(19) United States
(12) Patent Application Publication
(10) Pub. No.: US 2005/0146125 A1
(43) Pub. Date: Jul. 7, 2005

(54) ATV camping trailer

(76) Inventor: Steven A. Wheeler, West Haven, UT (US)

Correspondence Address: Steven A. Wheeler, 3664S. 3850W., West Haven, UT, 84401, US

(21) Appl. No.: 10/981,105

(22) Filed: Nov. 4, 2004

Related U.S. Application Data
(60) Provisional application No. 60/534,530, filed on Jan. 6, 2004.

(51) Int. Cl. B62D 63/06; B60F 1/00

(52) U.S. Cl. 280/789

(57) ABSTRACT

This invention is a camping trailer towed by an ATV or off road vehicle. The trailer has a frame of steel or metallic material and a body of plastic or composite plastic which houses a perpendicular arc shelter when the inner tongue is extended and rotated forward onto the supporting movable tray and storage box. The trailer suspension is an axle which supports a plurality of wheels rotatable about an axes that are fixed with respect to a triangular device where the triangular device itself is rotated about an axis so that the wheels attached to the triangular plate will rotate or climb over uneven or rough terrain.

### BACKGROUND OF THE INVENTION

The field of the invention is ATV trailers.

Hunters and other outdoor enthusiasts frequently use all terrain vehicles (ATV'S) to travel into areas not accessible by other means of transportation (e.g. forested, rocky or steep terrains.) Trailers pulled behind ATVS need to be capable of traversing rocky terrain with numerous obstacles. The outdoor enthusiast needs to be able to traverse into the rough terrain and have a shelter in which to camp. This invention pertains to land vehicles generally, and more specifically to trailing vehicles configured for optimum performance with all terrain vehicles (ATVS), or off road vehicles. Several ATV trailers are known to exist. Prior Patent no, U.S. Pat. No. 6,017,081 discloses an off road trailer which expands but the method of expansion is different from present invention. Patent No. U.S. Pat. No. 5,375,902 discloses an ATV camping trailer with a top that opens forward but is unlike the present invention because of the suspension system patent No. U.S. Pat. No. 6,283,537 discloses an ATV camping trailer with a shelter that opens but is unlike this invention with no expandable tongue. U.S. Pat. No. 5,082,307 discloses an ATV trailer with an expandable tongue but does not include a shelter. U.S. Pat. No. 6,802,327 discloses a expandable shelter but not a trailer. U.S. Pat. No. 6,742,787 discloses a ATV trailer with a rotational axle assembly but is different from invention with no expandable shelter.

### BRIEF SUMMARY OF THE INVENTION

The invention is an off road all terrain (ATV) camping trailer designed to be pulled by an ATV, motorcycle, or an off road vehicle. The trailer is comprised of a trailer frame with a suspension axle assembly which is a plurality of wheels that rotate about an axes that are affixed to a triangular device or cluster arm where the device is rotated abut an axis so that the wheels will climb over uneven or rough terrain. A plastic or composite plastic bed which contains a shelter of canvas or flexible material which unfurls when the top section of the bed is rotated forward. The plastic bed is attached to the frame with bolts, screws or rivets. The trailer frame tongue extends forward to support a movable tray and storage box which supports the front top section of the bed. The object of the invention is to provide a shelter which will traverse rough terrain with a minimal movement of the trailer body.

### BRIEF DESCRIPTIONS OF THE DRAWINGS

FIG. 1. is a side expanded view.

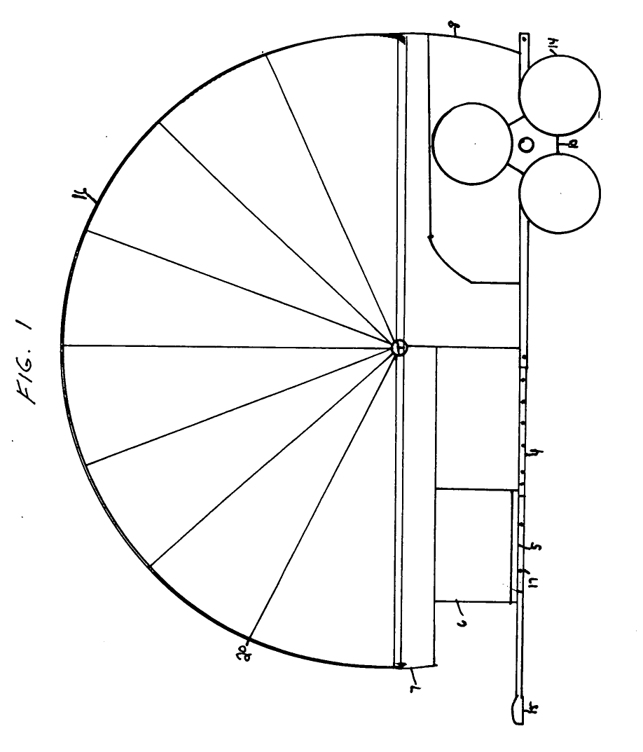

FIG. 2. is a top expanded view.

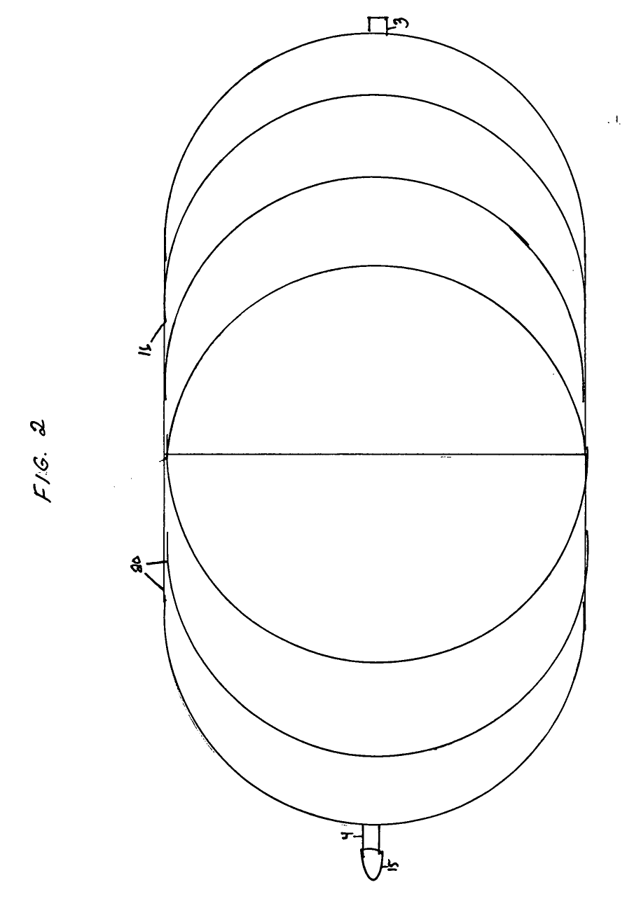

FIG. 3. is a rear expanded view.

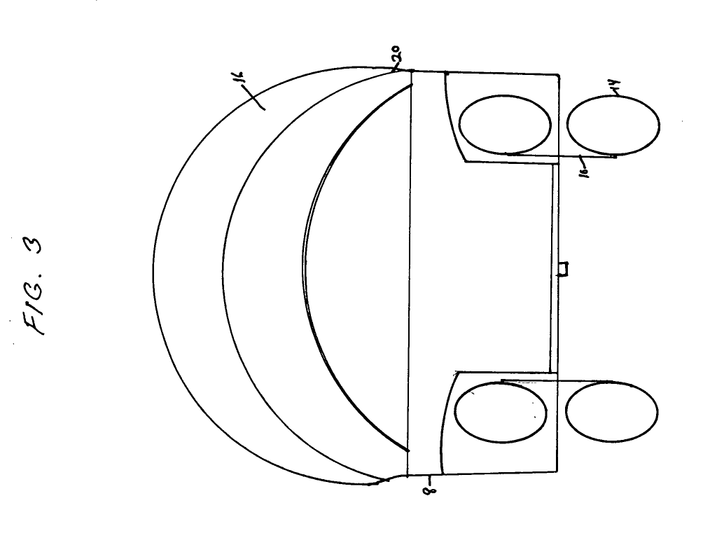

FIG. 4. is a rotational plate top view.

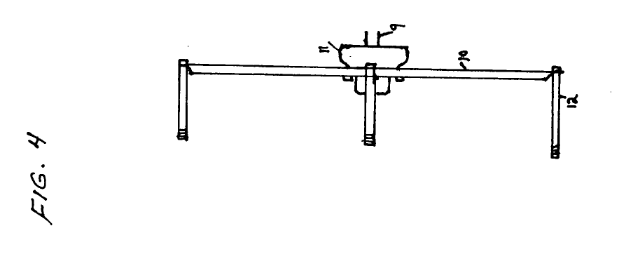

FIG. 5. is a side unexpanded view.

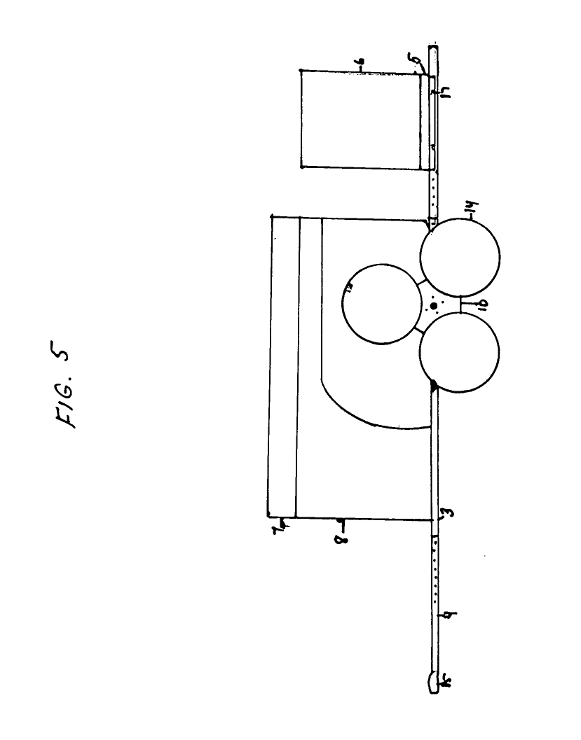

FIG. 6. is a rotational plate side view.

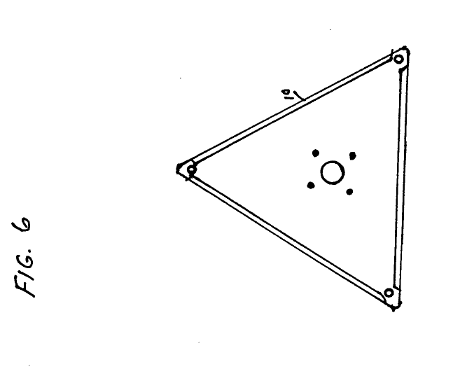

FIG. 7. is a movable tray with storage box side view.

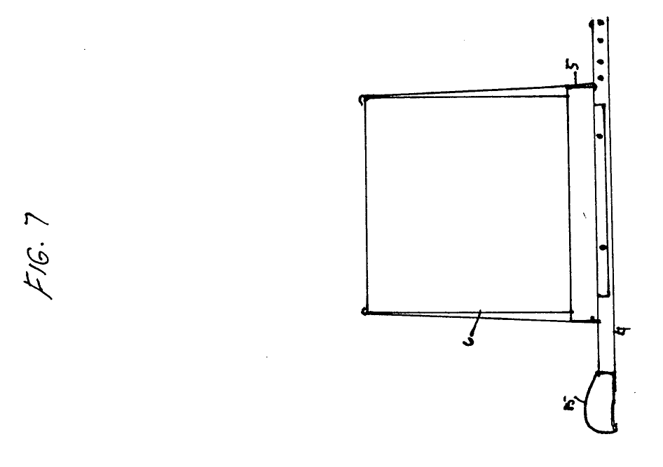

FIG. 8. is a movable tray bottom view.

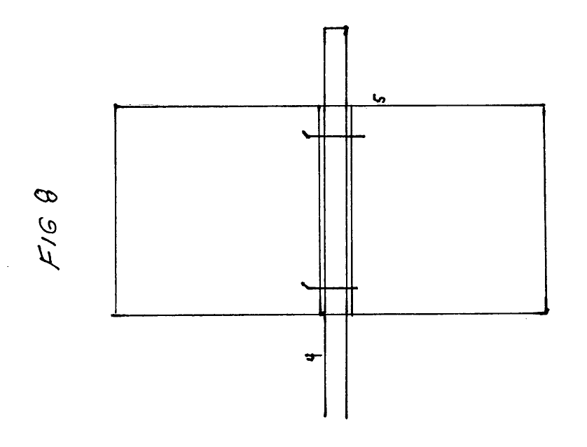

FIG. 9. is an unexpanded top view.

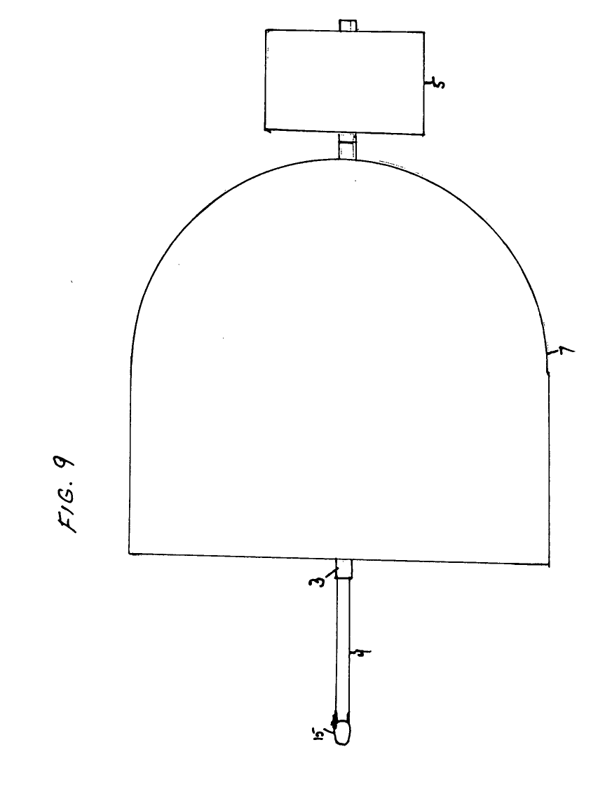

FIG. 10. is a unexpanded rear view.

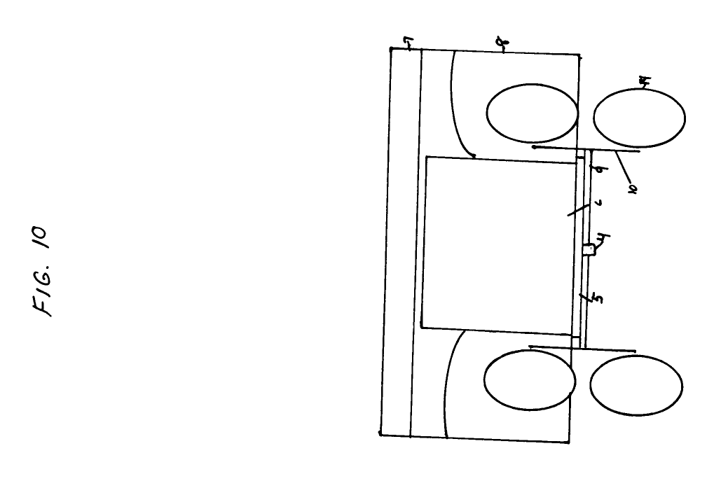

FIG. 11. is a top frame view.

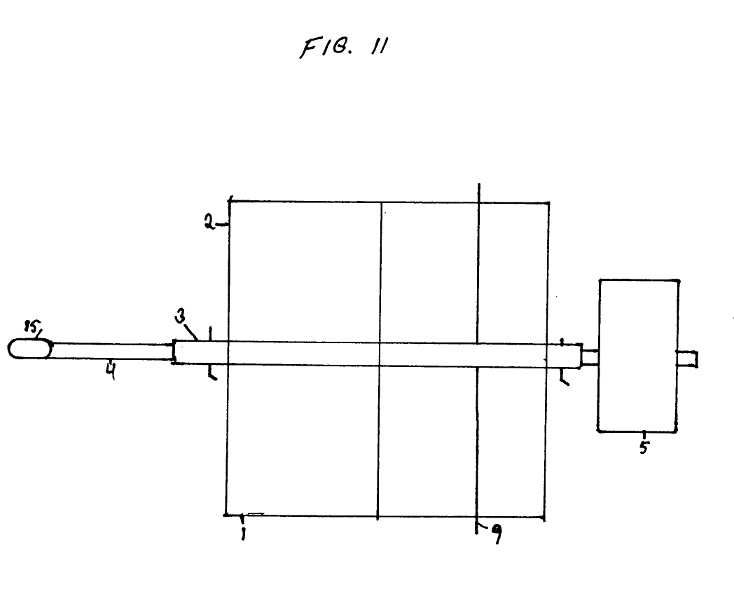

FIG. 12. is a pivot assembly side view.

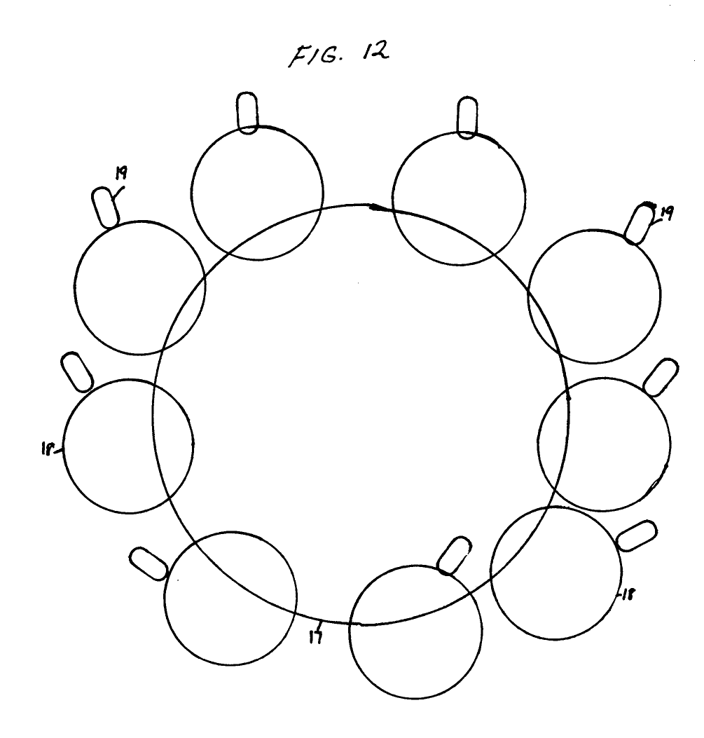

### DETAILED DESCRIPTION OF THE INVENTION

The ATV trailer is comprised of a frame work wherein all of the frame members are square tubing 1½ inches long and made of steel. The frame is comprised of at least 3 horizontal frame members (1) and at lease 4 parallel vertical frame members (2). The drawings show the preferred configuration wherein the frame has 3 horizontal parallel frame members (1) and 4 parallel vertical frame members (2).

The center horizontal frame member (3) is a steel tube of a larger dimension which houses a steel tube of a smaller dimension forming a inner tongue (4). The smaller inner tongue (4) extends forward to support a movable tray (5) which in turn supports a storage box (6). The storage box (6), movable tray (5), and inner tongue(4) support the top front bed section (7). The trailer is attached to the tow vehicle by means of a coupler (15).

The trailer suspension is comprised of the 2nd vertical member which is a split axle (9) that is attached to the rotational triangular plate assembly (10). The rotational triangular plate assembly is comprised of a triangular shaped plate (10) which is attached to a hub (11) that is attached to the ends of the main axle (9). The stub axles (12) are bolted to the triangular plate (10) the hubs (11) are attached to each stub axle.

The wheels are attached to the stub axles (12) and the hubs (11). The tires (14) are mounted to the wheels and are of the same type and size as ATV tires to provide flotation and allow the trailer to travel in the same path as the ATV.

The trailer lower bed (8) and the top (7) are constructed of a plastic or composite plastic material and the lower bed (8) is attached to the frame members by bolts, rivets, or screws.

The fenders of the trailer are formed from the shape of the lower bed (8) which extends over the tires (14) and in front of the tires (14). The shape of the lower bed prevents mud, rocks, and other debris from splashing onto the operator of the tow vehicle.

The lower bed (8) houses a shelter (16) which when the top section (7) is rotated forward from the lower bed (8) unfurls forming a domed shelter cover (16). The shelter cover arrangement allows a user to obtain a shelter with a minimum of effort.

The movable tray (5) when the inner tongue (4) is retracted into the closed position is positioned on the rear of the lower bed (8) onto the inner tongue (4) by means of moving the tray and installing 2 hitch pins (17). The movable tray (5) when the inner tongue (4) is extended is placed on the inner tongue (4) at the front of the lower bed by means of 2 hitch pins (17). The top section (7) is supported by the inner tongue (4), the movable tray (5), and the storage box (6), when the trailer is in its extended position. This arrangement allows the trailer to remain attached to the tow vehicle and adds to the stability of the trailer when it is used as a shelter.

The central pivot point for the shelter (16) is comprised of a large diameter ring (17) which carries smaller rings (18) around its perimeter. The smaller rings have a stub (19) which allows the support poles (20) to be attached and removed when the shelter is stored in the lower bed (8). The large diameter ring is attached to the top front sides of the lower bed (8) with bolts through the central pivot point.

The support poles (20) are inserted through the fabric of the shelter (16) through sewn in pockets.

1. An ATV camping trailer that will traverse over uneven or rough terrain comprising;
a metal frame, wherein said frame is comprised of 3 horizontal frame and 2 or more vertical members, each member is connected to each other to form the “frame”,
a tongue consisting of an outer tongue and an extendable inner tongue,
a cluster arm rotatable about an axis characterized by a cluster angle, a “plurality of ground” contacting members are rotatable about a member axis fixed with respect to a cluster arm,
a trailer box constructed from a composite plastic material, said trailer box is rectangular at the front and rounded at the rear of box,
a flexible shelter attached to trailer box by means of an elastic bottom edge and comprised of a plurality of fame members arced to the same shape as the rounded end of composite box,
a central pivot point for said “shelter frame members” which carries smaller rings that support said “shelter frame members”,
a removable tray which attaches to extendable tongue by means of bolts or pins,
a removable storage box which can serve as a cooler.

2. A trailer according to claim 1 wherein the ground contacting members are Wheels attached to a cluster arm assembly.
